(19) United States
(12) Patent Application Publication
(10) Pub. No.: US 2015/0381595 A1
(43) Pub. Date: Dec. 31, 2015

(54) SYSTEM AND METHOD FOR MANAGING MULTIPLE DEVICES

(71) Applicants: Itzhak Shoshan, Petach Tikva (IL); Avi Rokach, Kfar Saba (IL)

(72) Inventors: Itzhak Shoshan, Petach Tikva (IL); Avi Rokach, Kfar Saba (IL)

(21) Appl. No.: 14/319,598

(22) Filed: Jun. 30, 2014

(51) Int. Cl. H04L 29/06; H04L 29/08

(52) U.S. Cl. CPC H04L 63/08; H04L 67/42; H04L 67/141

(57) ABSTRACT

A system and method for integrating a client application across multiple client devices is disclosed. A device management server receives a session request from a first client device, the session request indicating a second client device for a communication session. Upon receipt of the session request, the device management server transmits a security key to the first client device, and subsequently, receives the security key from the second client device. Upon receipt of the security key, the device management server establishes the communication session, and integrates the client application across the first and second client devices.

### FIELD OF INVENTION

The present invention generally relates to management of multiple electronic devices and, more particularly, to systems and methods for utilizing multiple electronic devices to perform a single task.

### BACKGROUND

In today's hyper information age, it is not uncommon for individuals to use and/or carry multiple electronic devices. Example devices include smartphones, laptop computers, desktop computers, tablets, wearable devices, and the like. Each of these device types may host similar (or duplicate) applications. For example, an individual may operate an e-mail or web-browsing application using any of these example electronic devices.

Until now, advances in computing technologies have focused on implementing smaller and/or more computationally powerful devices. As a result, commercially available smartphones and tablets continue to execute more sophisticated functions and applications. Thus, individuals often utilize smartphones and tablets to perform many of the functions that they previously performed on their personal and/or laptop computers. For example, individuals frequently view websites, e-mail, and calendar applications on their smartphones and tablets.

To date, however, application developers have yet to integrate functions across multiple devices. Although, it is not uncommon to link two devices using a USB cable, for example, the functions of a client application, especially when performing a single task, remain limited to a single device. A user typically chooses a single device to perform a task, and may alternate between devices as deemed convenient by the user.

In light of the drawbacks of existing electronic devices, the inventors have developed improved systems and methods for integrating applications across multiple devices.

### SUMMARY OF THE INVENTION

Accordingly, embodiments of the present invention are generally directed to systems and methods for integrating functions of multiple devices that substantially obviate one or more problems due to limitations and disadvantages of the related art.

Additional features and advantages of the embodiments will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the systems and methods for integrating functions of multiple devices include a device management server that receives a session request from a first client device, the session request indicating a second client device for a communication session. Upon receipt of the session request, the device management server transmits a security key to the first client device, and subsequently, receives the security key from the second client device. Upon receipt of the security key, the device management server establishes the communication session, and integrates the client application across the first and second client devices.

It is to be understood that both the foregoing general description and the following detailed description are examples intended to provide explanation of the embodiments of the invention as claimed.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure.

FIG. 1 is a simplified block diagram illustrating a distributed computing system that integrates functions for one or more application(s) across multiple devices according to an example embodiment.

FIG. 2 illustrates a method for implementing a multi-device session according to an example embodiment.

FIG. 3 illustrates a signal flow diagram for implementing a multi-device session according to an example embodiment.

FIGS. 4A-4B illustrate representative views of an example multi-device client application during an authentication process according to an example embodiment.

FIGS. 5A-5C illustrate representative views of an example multi-device client application implementing an integrated task according to an example embodiment.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

In order to increase user productivity and satisfaction, the embodiments provide systems and methods that leverage the unique capabilities of multiple device types. Countless applications may be integrated across multiple devices in numerous manners. The examples enumerated herein are merely intended to explain the various embodiments, but are not intended to limit the invention.

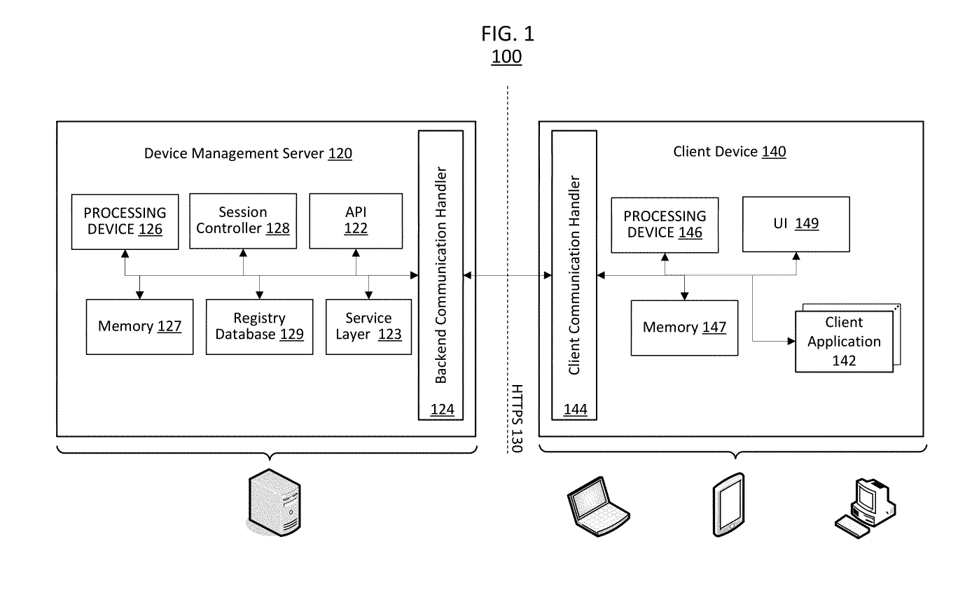

FIG. 1 is a simplified block diagram illustrating a distributed computing system 100 that integrates functions for one or more application(s) across multiple devices according to an example embodiment. As shown in FIG. 1, the distributed computing system 100 includes a device management server (DMS) 120 and client devices 140 that communicate across a network 130.

DMS 120 is an electronic computing device operable to receive, transmit, process, store, or manage information associated with the distributed computing system 100. DMS 120 may implement integration of one or more client applications 142 across multiple client devices 140. Among its functions, the DMS 120 may register client devices 140 and manage sessions between them.

DMS 120 may include a registry database 129. For example, the registry database 129 may store an entry for each user, and may store additional entries or sub-entries for each client device 140. Client devices 140 may be registered with DMS 120 by a user. In this manner, the registry database 129 may track each client device 140 associated with a particular user. In addition, the registry database 129 may include additional entries or sub-entries that indicate the functional capabilities of each registered client device 140. Example capabilities include whether a client device 140 contains particular hardware or software, such as a touchscreen, accelerometer, gyroscope, camera, sensor(s), GPS, operating system, installed application(s), security feature(s), and the like.

In some instances, such as corporate settings, a network administration may centrally determine the client devices 140 that may be included within registry database 129. In addition, a network administrator may also define, through a preference menu for example, one or more preferred client device(s) 140 for particular applications and/or associated tasks.

DMS 120 may include session controller 128. The session controller 128 may launch, manage, and/or terminate a communication session(s) between multiple client devices 140. Once a session is established, the session controller 128 may perform a variety of functions to facilitate integration of client application(s) 142 across multiple client devices 140. For example, session controller 128 may maintain data transmitted between client devices 140. In another example, session controller 128 may control user interfaces and other functions for each client device 140 that is active within an established session. In some instances, the session controller 128 may also synchronize the user interfaces (and/or other data) of each client device 140 that is active within an established session.

In some embodiments, session controller 128 may also include authentication modules to verify client devices 140. For example, authentication modules within session controller 128 may generate and distribute a “session ID” to each of the user's client devices 140. In some instances, such as less secure scenarios, DMS 120 may accept requests from client devices 140 that are not registered in the registry database 129.

Client devices 140 of a particular session may be selected by the user and/or automatically selected by the session controller 128. A variety of techniques may be used to ensure that particular client devices 140 are readily accessible by the user. Some example techniques verify that multiple devices are accessible by a user by transferring key data (e.g., random image, random audio, key code, etc.) between client devices 140.

For example, a camera of a second client device 140 may be adapted to take a picture of an image (e.g., a random image) displayed on a first client device 140 during a connection process. In another example, a microphone of second client device 140 may be adapted to record an audio segment (e.g., a random audio segment) played on a first client device 140 during a connection process. In yet another example, a user may retrieve a key code from DMS 120 via a first client device 140, and enter the code on a second client device during a connection process. In each of these examples, the session controller 128 may verify the data received at a second client device 140 (e.g., random image, random audio, key code, etc.). Other authentication mechanisms, such as face recognition, fingerprint sensors, and hand signatures may also be used.

Communications between client devices 140 that are associated with an established session may be encrypted. A variety of standard and/or propriety encryption techniques may be used to secure communications between client devices 140. Other techniques may be used to establish a secure session between multiple client devices 140, including the use of short range wireless signals (e.g., NFC, RFID, Bluetooth, Wi-Fi, etc.).

In some implementations, components of the DMS 120, both hardware and/or software, may interface with each other and/or other devices within the distributed computing system 100 using an application programming interface (API) 122 and/or a service layer 123. The API 122 may include specifications for routines, data structures, and object classes. The service layer 123 provides software services to devices within the distributed computing system 100. The functionality of DMS 120 may be accessible for all service consumers using this service layer 123. Software services may provide reusable, defined business functionalities through a defined interface. For example, the interface may be software written in JAVA, C++, or other suitable programming languages providing data in extensible markup language (XML) format or other suitable format(s).

While illustrated as an integrated component of the DMS 120, alternative implementations may provide the API 122 and/or service layer 123 as a stand-alone component in relation to other components of the distributed computing system 100. Moreover, components of the API 122 and/or service layer 123 may be implemented as child or sub-modules of another software module, client application, or hardware module without departing from the scope of this disclosure.

DMS 120 may include a communications interface 124. Although illustrated as a single communications interface 124 in FIG. 1, two or more communications interfaces 124 may be used according to particular needs or implementations of the DMS 120. The communications interface 124 is used by DMS 120 for communicating with other systems, such as example client devices 140, in the distributed computing system 100 using the network 130 as well as other systems communicably coupled to the network 130 (not shown). Generally, the communications interface 124 comprises logic encoded in software and/or hardware in a suitable combination and operable to communicate with the network 130. More specifically, the communications interface 124 may comprise software supporting one or more standard and/or proprietary communication protocols.

DMS 120 includes a processing device 126 that may perform computation and control functions of DMS 120 and comprises a suitable central processing system. Processing device 126 executes instructions and manipulates data to perform the operations of the DMS 120. For example, the processor 126 executes the functionality required to provide integration of a client application across multiple client devices, including user interface integration. Processing device 126 may include a single integrated circuit, such as a microprocessing device, or may include any suitable number of integrated circuit devices and/or circuit boards working in cooperation to accomplish the functions of a processing device. Processing device 126 may execute computer programs, such as applications or object-oriented computer programs, within memory 127.

DMS 120 also includes a memory 127 that may include a computer readable medium for storing application modules as well as data objects and instructions associated with application modules of the DMS 120. Although illustrated as a single memory 127 in FIG. 1, two or more storage devices may be used according to particular needs or particular implementations of the DMS 120. While memory 127 is illustrated as an integral component of the DMS 120, in alternative implementations, memory 127 can be external to DMS 120.

In an embodiment, memory 127 may contain different components for retrieving, presenting, changing, and saving data and may include computer readable media. Memory 127 may include a variety of memory devices, for example, Dynamic Random Access Memory (DRAM), Static RAM (SRAM), flash memory, cache memory, and other memory devices. Additionally, for example, memory 127 and processing device(s) 126 may be distributed across several different computers that collectively comprise a system. Memory 127 may be capable of storing user inputs and preferences as well as customized displays and templates. In some instances, a cache in memory 127 may store data objects or instructions being shared by multiple client devices 140.

The client device 140 may be any computing device operable to connect to or communicate with at least the DMS 120 using the network 130. In general, the client device 140 may be an electronic computer device operable to receive, transmit, process, and store any appropriate data associated with distributed computing system 100. Example client devices 140 include smartphones, laptop computers, desktop computers, tablets, wearable devices, smart televisions, smart cars, and the like.

The example client device 140 includes one or more client applications 142. A client application 142 may be any type of software application that allows a user to request, view, process, and/or manage content associated with DMS 120 and/or other client devices 140. A typical client application 142 generally includes operational logic (not shown). The operational logic may perform data entry, updating, querying, reporting, and/or other suitable task(s) for the client application 142.

Once a particular client application 142 is launched, a user may interactively process a task, event, or other information associated with the client application 142. The client application 142 may be adapted to perform tasks across multiple client devices 140. In some implementations, the client application 142 may further receive, use, display, modify, and/or perform other suitable functions on content, parameters, metadata, and/or other information received from and/or associated with the DMS 120 and/or other client devices 140.

In some instances, the client application 142 may be part of a business solution or enterprise software having one or more functions enabled by DMS 120. In these embodiments, the business solution or enterprise software may execute a plurality of instructions originating from multiple client devices 140. For example, a customer relationship management (CRM) system may manage contact information across multiple client devices (e.g., desktop computer and smartphone). In this example, the CRM system may enable a first function, such as entry of new data using a first client device, while the user is simultaneously performing a second function, such as executing calls using system contact information or uploading multimedia data, on a second device.

Client device 140 includes user interface modules 147. In general, the user interface modules 147 generate a visual representation of generated content and provide interactive functionality for a user of client device 140. The generated content may originate with one or more components of the client device 140, other client devices 140, DMS 120, and/or other components of the distributed computing system 100. The user interface modules 147 also provide interactive functionally with the client application 142 and/or other client devices 140. In addition, user interface modules 147 may track other synched client devices 140 and determine best suited controls for the user session.

Client 140 further includes a communications interface 144, a processor 146, and a memory 147. These components may be consistent with and adapted to cooperate with the above described components of DMS 120, and may be used by the client device 140 for communicating with other computing systems, as well as storing and executing client applications 142.

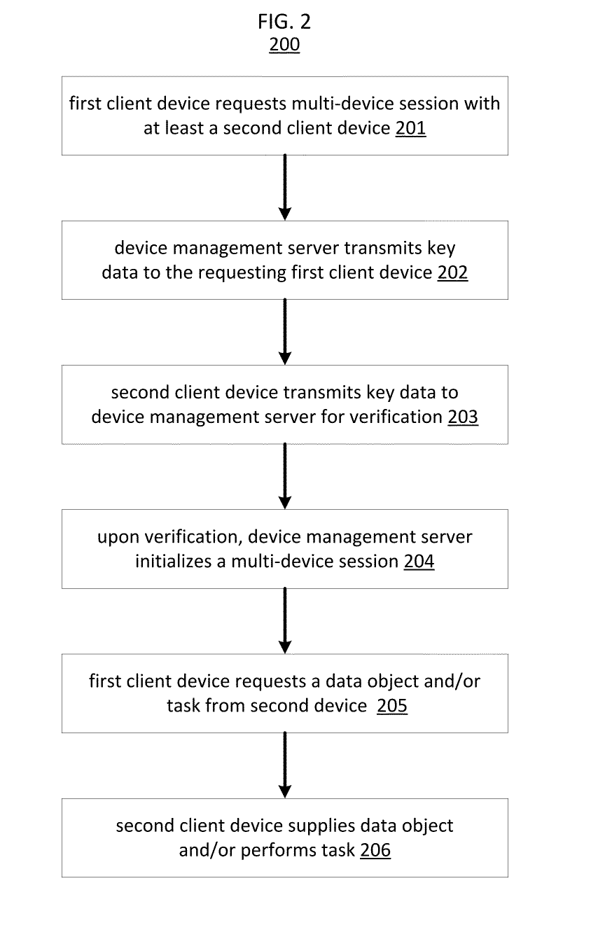

FIG. 2 illustrates a method 200 for implementing a multi-device session according to an example embodiment. The method 200 may be used to integrate applications of client devices 140.

As depicted in FIG. 2, a first client device 140a may send a multi-device session request to DMS 120, at 201. In some instances, a user of the first client device 140a may further indicate the other client device(s) 140b for inclusion in the requested multi-device session.

In response to the multi-device session request, DMS 120 may transmit security key data to the requesting first client device 140a, at 202. Examples of security key data include random image(s), random audio stream(s), key code(s), etc.

Next, at 203, the second client device 140b transmits security key data to the DMS server 102 for verification. Here, the user of client devices 140 may transfer the security key data from the first to the second client device. For example, a camera of a second client device 140b may be adapted to take a picture of an image (e.g., a random image) displayed on a first client device 140a. In another example, a microphone of second client device 140b may be adapted to record an audio stream played by the speakers of a first client device 140a. In yet another example, a user may retrieve a security key code from DMS 120 via the first client device 140a, and enter the code on a second client device 140b. Once the security key data is stored, it may be transmitted by the second client device 140b to the DMS 120 for verification.

The session controller 128 of DMS 120 may verify security key data received from the second client device 140b. Upon verification, DMS 120 may initialize a multi-device session pursuant to the initial request of the first client device 140a, at 204. For example, the authentication modules within session controller 128 may generate and distribute a “session ID” to each of the user's client devices 140 designated for a particular session.

During a session, data objects may be shared and performance of tasks may be integrated between participating client devices 140. A first client device 140a may request a data object or performance of a task from a second client device 140b, at 205. For example, while a user is operating a first client device 140a (e.g., a laptop computer), a second client device 140b (e.g., a smartphone with a touchscreen) may be requested to provide a screen to receive a digital hand signature. In other examples, a user may operate a smartphone accelerometer as a 3D mouse, or operate a smartphone camera to scan an invoice. Lastly, the second client device 140b supplies the requested data objects and/or performs requested tasks, at 206.

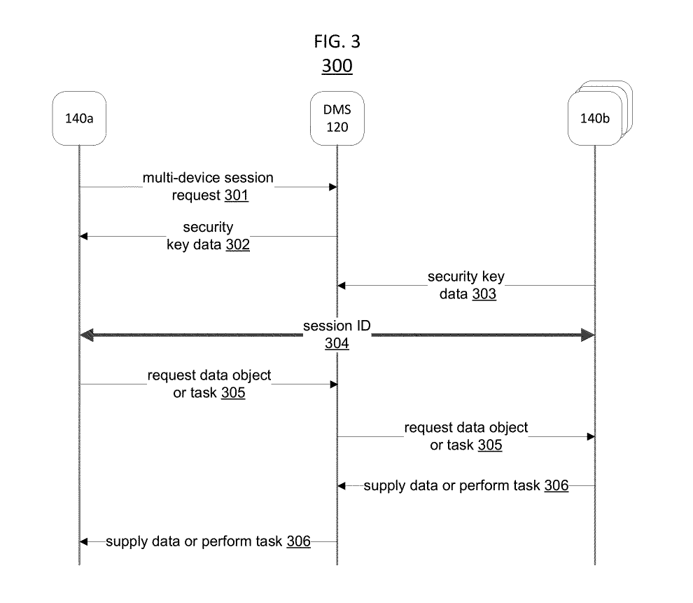

FIG. 3 illustrates a signal flow diagram 300 for implementing a multi-device session according to an example embodiment. FIG. 3 illustrates communications among a first client device 140a, one or more second client devices 140b, and DMS 120.

As shown in FIG. 3, the first client device 140a may send a multi-device session request 301 to DMS 120 to initiate a multi-device session. In response to the multi-device session request 301, DMS 120 may transmit security key data 302 to the requesting first client device 140a. Examples of security key data include random image(s), random audio stream(s), key code(s), etc. Here, the user of client devices 140 may cause the security key data to be transferred from the first to the second client device. Once the security key data is stored, it may be transmitted by the second client device 140b to the DMS 120 for verification. The DMS 120 may verify security key data received from the second client device 140b. Upon verification, DMS 120 may initialize a multi-device session by distributing a session ID 304 to each of the client devices 140 designated for a particular session. During a session, a first client device 140a may request a data object or performance of a task from a second client device 140b, at 305. Lastly, the second client device 140b supplies the requested data objects and/or performs requested tasks, at 306. Communications 305 and 306 may be peer-to-peer communications using standard and/or propriety protocols, or may be communications through DMS 120 via network 130.

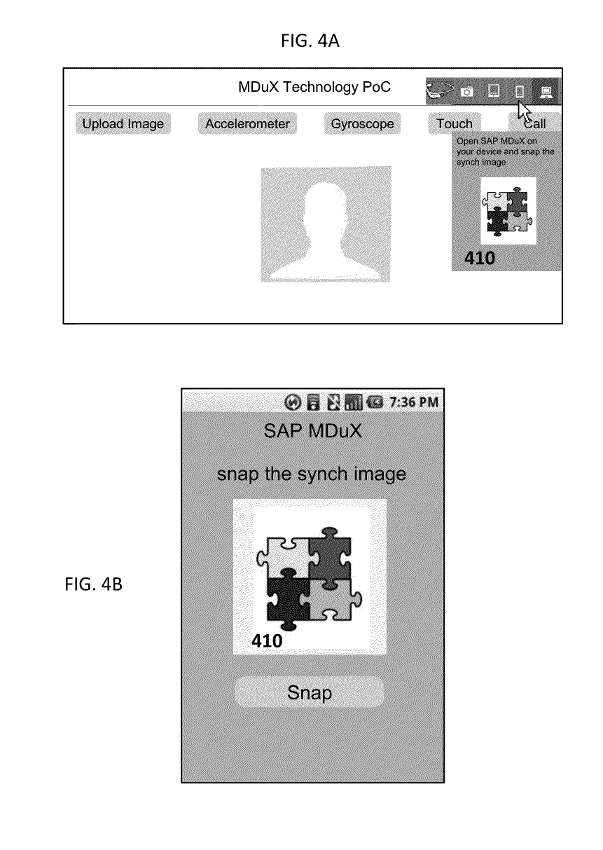

FIGS. 4A-4B illustrate representative views of an example multi-device client application during an authentication process according to an example embodiment. In particular, FIG. 4A may depict a representative view of a first client device 140a (e.g., a laptop computer), and FIG. 4B may depict a representative view of a second client device 140b (e.g., a smartphone). As illustrated by FIGS. 4A and 4B, a camera of a second client device 140b may be adapted to take a picture of an image 410 (e.g., a random image) displayed on a first client device 140a during an authentication connection process.

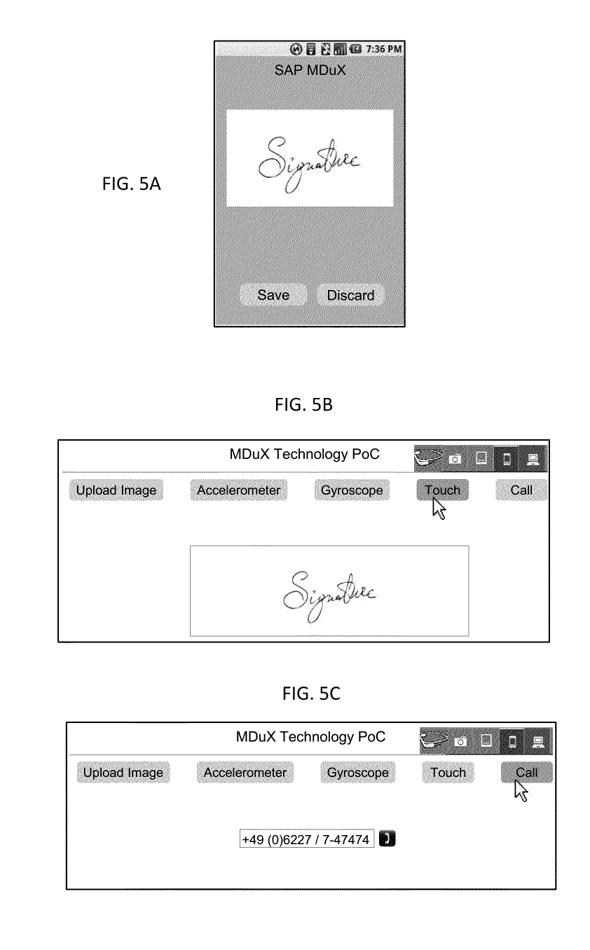

FIGS. 5A-5C illustrate representative views of an example multi-device client application implementing an integrated task according to an example embodiment. In particular, FIG. 5A may depict a representative view of a second client device 140b (e.g., a smartphone), and FIGS. 5B and 5C may depict representative views of a first client device 140a (e.g., a laptop computer). As illustrated by FIGS. 5A and 5B, while a user is operating a first client device 140a, a second client device provides a screen to receive a digital hand signature. Similarly, FIG. 5C illustrates the initiation of a telephone call on a second client device 140b (e.g., a smartphone) from a first client device (e.g., a laptop computer). Here, the telephone number (e.g., a data object) is transferred between the client devices.

The foregoing description has been presented for purposes of illustration and description. It is not exhaustive and does not limit embodiments of the disclosure to the precise forms disclosed. It will be apparent to those skilled in the art that various modifications and variations can be made in the systems and methods for managing multiple devices of the present disclosure without departing from the spirit or scope of the disclosure. Thus, it is intended that the present disclosure cover the modifications and variations of this disclosure provided they come within the scope of the appended claims and their equivalents.

We claim:

1. A method for integrating a client application across multiple devices, the method comprising:
receiving, at a device management server, a session request from a first client device, the session request indicating a second client device for a communication session;
upon receipt of the session request, transmitting a security key to the first client device;
receiving, at the device management server, the security key from the second client device;
upon receipt of the security key, establishing the communication session; and
integrating the client application across the first and second client devices.

2. The method according to claim 1, wherein the security key includes a random image.

3. The method according to claim 1, wherein the security key includes a random audio stream.

4. The method according to claim 1, wherein the device management server transmits a session identifier to each of the first and second client devices to establish the communication session.

5. The method according to claim 1, wherein data objects of the client application are shared between the first and second client devices during the communication session.

6. The method according to claim 5, wherein one of the data objects is a telephone number.

7. The method according to claim 5, wherein one of the data objects includes image data.

8. A non-transitory computer readable storage medium storing one or more programs configured to be executed by a processor, the one or more programs comprising instructions for:
receiving, at a device management server, a session request from a first client device, the session request indicating a second client device for a communication session;
upon receipt of the session request, transmitting a security key to the first client device;
receiving, at the device management server, the security key from the second client device;
upon receipt of the security key, establishing the communication session; and
integrating a client application across the first and second client devices.

9. The non-transitory computer readable storage medium according to claim 8, wherein the security key includes a random image.

10. The non-transitory computer readable storage medium according to claim 8, wherein the security key includes a random audio stream.

11. The non-transitory computer readable storage medium according to claim 8, wherein the device management server transmits a session identifier to each of the first and second client devices to establish the communication session.

12. The non-transitory computer readable storage medium according to claim 8, wherein data objects of the client application are shared between the first and second client devices during the communication session.

13. The non-transitory computer readable storage medium according to claim 12, wherein one of the data objects is a telephone number.

14. The non-transitory computer readable storage medium according to claim 12, wherein one of the data objects includes image data.

15. An electronic device comprising:
one or more processors; and
memory storing one or more programs for execution by the one or more process, the one or more programs including instructions for:
receiving, at the electronic device, a session request from a first client device, the session request indicating a second client device for a communication session;
upon receipt of the session request, transmitting a security key to the first client device;
receiving, at the device management server, the security key from the second device;
upon receipt of the security key, establishing the communication session; and
integrating a client application across the first and second client devices.

16. The electronic device according to claim 15, wherein the security key includes a random image.

17. The electronic device according to claim 15, wherein the security key includes a random audio stream.

18. The electronic device according to claim 15, wherein the device management server transmits a session identifier to each of the first and second client devices to establish the communication session.

19. The electronic device according to claim 15, wherein data objects of the client application are shared between the first and second client devices during the communication session.

20. The electronic device according to claim 16, wherein one of the data objects is a telephone number.

21. The electronic device according to claim 16, wherein one of the data objects includes image data.

22. A method for integrating a client application across multiple devices, the method comprising:
receiving, at a device management server, a session request from a first client device, the session request indicating a second client device for a communication session;
upon receipt of the session request, transmitting a security key to the first client device;
receiving, at the device management server, the security key from the second client device;
upon receipt of the security key, establishing the communication session; and
integrating the client application across the first and second client devices, wherein the a first function of the client application is implemented at the first client device, and a second function of the client application is simultaneously implemented at the second device.
